(19) United States
(12) Patent Application Publication
(10) Pub. No.: US 2024/0324071 A1
(43) Pub. Date: Sep. 26, 2024

(54) DEVICE FOR HEATING GRAPHITE FOR VACUUM SINTERING FURNACE

(71) Applicant: Shanghai Fusion Tech Co., Ltd., Shanghai (CN)

(72) Inventors: Wei Mai, Shanghai (CN); Sheng Zhu, Shanghai (CN); Linggang Hu, Shanghai (CN); Chong Wang, Shanghai (CN); Jingjing Qian, Shanghai (CN); Hua Feng, Shanghai (CN); Jianzhe Li, Shanghai (CN); Jinjing Zhang, Shanghai (CN)

(73) Assignee: Shanghai Fusion Tech Co., Ltd., Shanghai (CN)

(21) Appl. No.: 18/616,124

(22) Filed: Mar. 25, 2024

(30) Foreign Application Priority Data
Mar. 24, 2023 (CN) 202310295087.9

(51) Int. Cl. H05B 3/14; H05B 3/62

(52) U.S. Cl. CPC H05B 3/145; H05B 3/62

(57) ABSTRACT

Devices for heating graphite for a vacuum sintering furnace are disclosed. In some examples, the device includes a heating unit. The heating unit includes a heating conductive strip, a fixing conductive block, a connecting conductive strip, and an isolating column. The plurality of heating conductive strips are connected end-to-end through the fixing conductive block to form a closed frame. One end of the connecting conductive strip is fixedly connected to one of the fixing conductive blocks, and the other end thereof is a free end. One of the two heating conductive strips communicated with the fixing conductive block provided with the connecting conductive strip is connected to the fixing conductive block through the isolating column. The plurality of heating units are disclosed. The heating conductive strips of the plurality of heating units connected to the isolating column are electrically connected through the connecting heating block.

### CROSS REFERENCE TO RELATED APPLICATIONS

This application claims priority to Chinese patent application number 202310295087.9, filed on Mar. 24, 2023, the disclosure of which is incorporated by reference herein in its entirety.

### FIELD OF THE DISCLOSURE

The disclosure relates generally to the field of metal sintering or metal heat treatment. More specifically, the disclosure relates to devices for heating graphite for vacuum sintering furnaces.

### BACKGROUND

The current development of rapid modeling technology of a metal powder leads an MIM industry and an 3D printing industry into a period of rapid development. The rapid modeling of the metal powder requires a molded sample to be sintered. The sintered sample can achieve the denseness of a metal. To ensure that a powder billet is decreased, reduced, alloyed, tissue-transformed smoothly in a sintering process, a sintering temperature is critical. The structural design of a heating body plays a decisive role in the temperature, which ensures that the high temperature can be achieved while meeting a certain degree of temperature uniformity.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the disclosure provides a graphite heating device for a vacuum sintering furnace including a plurality of heating units.

Each one of the plurality of heating units includes a plurality of heating conductive strips, a conductive block, a connecting conductive strip, and an isolating column, the plurality of heating conductive strips are connected end-to-end through the conductive block to form a closed frame, and one end of the connecting conductive strip is connected to one of the conductive block, and another end of the connecting conductive strip is a free end.

One of the plurality of heating conductive strips is connected to the conductive block through the isolating column.

Pluralities of heating conductive strips of the plurality of heating units connected to the isolating column are electrically connected through a connecting heating block.

Optionally, multiple heating conductive strips are provided between two adjacent conductive blocks. The multiple heating conductive strips are provided in parallel to each other.

Optionally, the two adjacent conductive blocks are connected to each other by an insulating plate.

Optionally, a longitudinal cross-section of the conductive block is in an L-shape. Another one of the plurality of heating conductive strips is connected to the conductive block via a conductive screw.

Optionally, the isolating column is provided on an outer surface of the conductive block.

Optionally, the plurality of heating conductive strips are graphite heating conductive strips. The conductive block is a graphite conductive block. The connecting conductive strip is a graphite connecting conductive strip. The connecting heating block is a graphite connecting heating block.

Optionally, the isolating column is an insulating isolating column.

In other embodiment, the disclosure provides a graphite heating device for a vacuum sintering furnace includes a heating unit. The heating unit includes a heating conductive strip, a fixing conductive block, a connecting conductive strip, and an isolating column. The plurality of heating conductive strips are connected end-to-end through the fixing conductive block to form a closed frame. One end of the connecting conductive strip is fixedly connected to one of the fixing conductive blocks, and the other end thereof is a free end.

One of the two heating conductive strips communicated with the fixing conductive block provided with the connecting conductive strip is connected to the fixing conductive block through the isolating column.

The plurality of heating units are disclosed. The heating conductive strips of the plurality of heating units connected to the isolating column are electrically connected through the connecting heating block. The connecting heating block and the heating conductive strip are connected to each other via a conductive screw.

When device for heating graphite for a vacuum sintering furnace as described in the disclosure is used, two connecting conductive strips of a heating unit are selected. One connecting conductive strip is communicated with a positive electrode of a power supply, and the other connecting conductive strip is communicated with a negative electrode of the power supply.

A current flows through a fixing conductive block of the heating unit to the heating conductive strip, and then flows from the heating conductive strip to the fixing conductive block. Because the fixing conductive block connected to the connecting conductive strip is provided, one of the two heating conductive strips communicate with each other is connected to the fixing conductive block through the isolating column. The current flowing through the heating conductive strip flows through the connecting conductive block to the next heating unit.

For the device for heating the graphite for the vacuum sintering furnace, as an optional embodiment, the plurality of heating conductive strips located between the two adjacent fixing conductive blocks are disclosed. The plurality of heating conductive strips are provided in parallel.

For the device for heating the graphite for the vacuum sintering furnace, as an optional embodiment, the two adjacent fixing conductive blocks are fixedly connected to each other by an insulating plate. The insulating plate is fixedly connected to the fixing conductive block by a screw.

For the device for heating the graphite for the vacuum sintering furnace, as an optional embodiment, the longitudinal cross-section of the fixing conductive block is L-shaped. The heating conductive strip is connected to the fixing conductive block via a conductive screw.

The conductive screw used in the disclosure are processed from a CC composite material, which has high strength and maintains strength and an excellent fastening property even after undergoing with a high temperature.

For the device for heating the graphite for the vacuum sintering furnace, as an optional embodiment, the fixing conductive block is provided with the isolating column on the outer surface. The isolating column and the fixing conductive block are screwed or embedded to each other.

Because in the process of use, the exterior of the device described in the disclosure needs to be sleeved with a heat-preservation assembly, to prevent the conduction between the device and the heat-preservation assembly, the isolating column is provided on the exterior surface of the fixing conductive block, so that a certain gap between the device and the heat-preservation assembly is provided.

For the device for heating the graphite for the vacuum sintering furnace, as an optional embodiment, the heating conductive strip is a graphite heating conductive strip. The fixing conductive block is a graphite fixing conductive block. The connecting conductive strip is a graphite connecting conductive strip. The connecting heating block is a graphite connecting heating block.

The graphite has excellent processing performance and high temperature resistance, and is an excellent material for a heat generator.

Optionally, the isolating column is an insulating isolating column (optionally a ceramic isolating column). The insulating plate is a ceramic insulating plate.

Ceramics is resistant to high temperatures and has an excellent insulating property.

### BRIEF DESCRIPTION OF THE DRAWINGS

Illustrative embodiments of the present disclosure are described in detail below with reference to the attached drawing figures.

FIG. 1 is a schematic structural diagram of a heating unit of a device for heating a graphite for a vacuum sintering furnace according to an embodiment of the disclosure.

FIG. 2 shows a schematic structural diagram of a device for heating a graphite for a vacuum sintering furnace according to an embodiment of the disclosure.

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

To enable a person skilled in the art to better understand the embodiments of the disclosure, the following clearly and completely describes the technical solutions in embodiments of the disclosure in conjunction with a case of the disclosure. Obviously, the described embodiments are a part of the embodiments of the disclosure, rather than all embodiments. Based on the embodiments of the disclosure, all other embodiments obtained by a person skilled in the art without inventive work shall fall within the protection scope of the disclosure.

In the disclosure, orientation or positional relationships indicated by the terms “upper”, “lower”, “left”, “right”, “front”, “back”, “top”, “bottom”, “inside”, “outside”, “middle”, “vertical”, “horizontal”, “transverse”, “longitudinal”, etc., are orientation or positional relationships based on the accompanying drawings. These terms are used primarily to better describe the disclosure and the embodiments thereof, and are not intended to define that indicated devices, elements, or assemblies should have a particular orientation, or be constructed and operated in a particular orientation.

Moreover, some of the forgoing terms may be used to indicate other meanings in addition to the orientation or positional relationships, for example, the term “upper” may also be used in some cases to indicate some relationship of dependency or connection. For a person skilled in the art, the specific meaning of these terms in the disclosure may be understood based on specific situations.

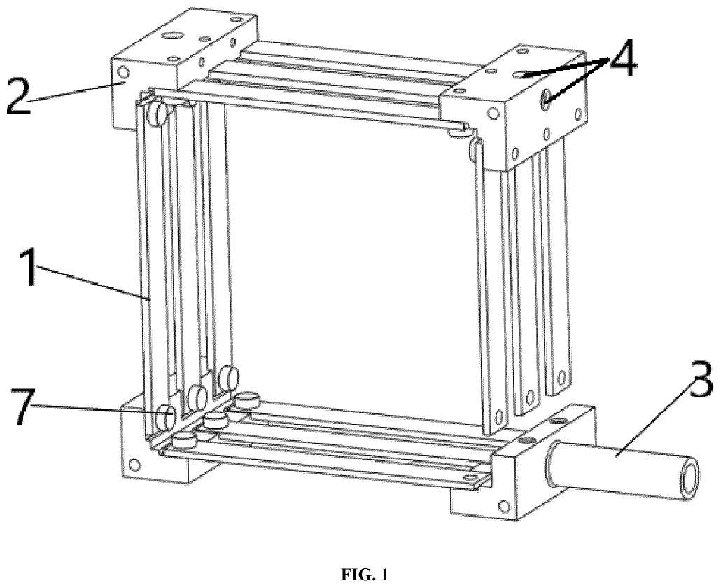

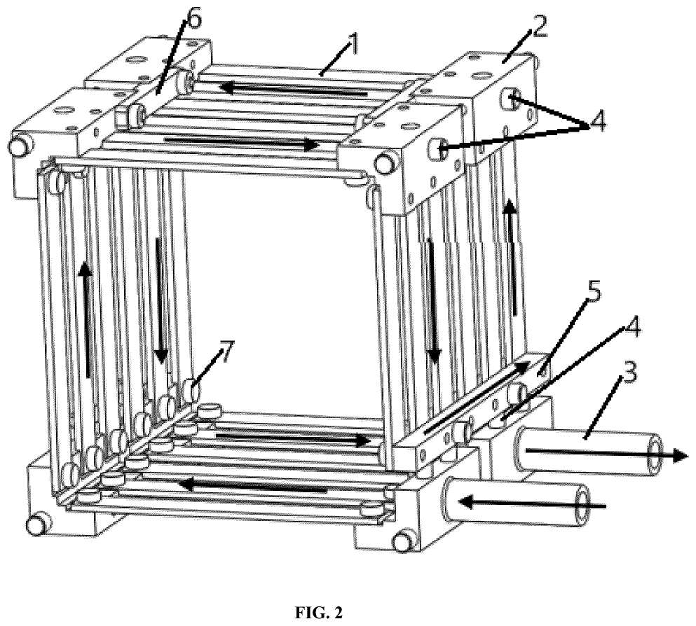

In FIGS. 1 and 2, 1 represents heating conductive strip, 2 represents fixing conductive block, 3 represents connecting conductive strip, 4 represents isolating column, 5 represents connecting heating block, 6 represents insulating plate, and 7 represents conductive screw.

In examples as shown in FIGS. 1 and 2, a graphite heating device for a vacuum sintering furnace may include a heating unit. The heating unit may include a heating conductive strip 1, a fixing conductive block 2, a connecting conductive strip 3, and an isolating column 4. The plurality of heating conductive strips 1 are connected end-to-end through the fixing conductive block 2 to form a closed frame. One end of the connecting conductive strip 3 is fixedly connected to one end of the fixing conductive block 2, and the other end thereof is a free end.

One of the two heating conductive strips 1 communicated with the fixing conductive block 2 provided with the connecting conductive strip 3 is connected to the fixing conductive block 2 through the isolating column 4. The plurality of heating units are disclosed. The heating conductive strips 1 of the plurality of heating units connected to the isolating column 4 are electrically connected 1 through the connecting heating block 5. The isolating column 4 is made of a ceramic material with excellent high-temperature resistance and adiabatic properties.

The device described in the embodiment uses the graphite as a heating body, i.e. the heating conductive strip 1, the fixing conductive block 2, the connecting conductive strip 3, and the connecting heating block 5 used in the embodiment are all made of the graphite.

The heating unit described in the embodiment is square-shaped. The four heating conductive strips 1 are connected end-to-end by the fixing conductive block 2 to form a square-shaped closed frame. To increase the heating area, the three heating conductive strips 1 are provided in parallel between the two adjacent fixing conductive blocks 2. The longitudinal cross-section of the fixing conductive block 2 adopted in the embodiment is L-shaped. The heating conductive strip 1 is connected to the fixing conductive block 2 via a conductive screw 7, to ensure that the device is tightly constructed. Because in the process of use, the exterior of the device needs to be sleeved with a heat-preservation assembly, to prevent the conduction between the heat-preservation assembly and the device, the isolating column 4 is provided on the exterior surface of the fixing conductive block 2, so that a certain gap of between the device and the heat-preservation assembly is provided.

To increase the stability of the device, the two adjacent fixing conductive blocks 2 are fixedly connected to each other by the insulating plate 6. One end of the insulating plate 6 is fixedly connected to one of the two adjacent fixing conductive blocks 2, and the other end thereof is fixedly connected to the other of the two adjacent fixing conductive blocks 2. The insulating plate 6 is made of a ceramic material with excellent high-temperature resistance and adiabatic properties.

When the device for heating the graphite for the vacuum sintering furnace described in this embodiment, (as shown in FIG. 2) one connecting conductive strip 3 of the two heating units is communicated with a positive electrode of a power supply, and the other is communicated with a negative electrode of the power supply. A current flows through the fixing conductive block 2 communicated with the positive electrode of the power supply in sequence, flows into the connecting conductive strip 3, then flows through the fixing conductive block 2 into the connecting conductive strip 3, then flows through the connecting heated block 5 into the heating conductive strip 1 of the other heating unit, flows through the heating conductive strip 1 into the fixing conductive block 2, and finally flows through the connecting conductive strip 3 into the negative electrode of the power supply, thereby forming a closed loop.

Various embodiments of the disclosure may have one or more of the following effects. In some embodiments, the disclosure provides a sintering zone (a frame enclosed by a heating conductive strip is the sintering zone) that may achieve high temperature uniformity using graphite as a heat generator. The sintering zone may enable a space utilization rate to be up to 95% in an internal heating zone with a temperature difference within 5° C. A graphite heating device for a vacuum sintering furnace with a compact structure, low heat dissipation and reduced energy consumption may be provided. In other embodiments, the disclosure may have one or more of the following beneficial effects: the device for heating the graphite for the vacuum sintering furnace described in the disclosure may adopt the graphite as a heat generator, which may be mounted in a more compact manner, achieving a highly efficient hot field zone and ensures the uniformity of the temperature in a sintering zone and, at the same time, reducing an overall mounting space. In further embodiments, the device for heating the graphite for the vacuum sintering furnace described in the disclosure may be easy to disassemble, easy to maintain, and easy to process, and may have a low cost.

The forgoing is only the optional embodiments of the disclosure. It should be noted that the person skilled in the art may make several improvements and supplements without departing from the method of the disclosure, and these improvements and supplements should also be considered as the protection scope of the disclosure.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. A graphite heating device for a vacuum sintering furnace, comprising a plurality of heating units, wherein:
each one of the plurality of heating units comprises a plurality of heating conductive strips, a conductive block, a connecting conductive strip, and an isolating column, the plurality of heating conductive strips are connected end-to-end through the conductive block to form a closed frame, and one end of the connecting conductive strip is connected to one of the conductive block, and another end of the connecting conductive strip is a free end;
one of the plurality of heating conductive strips is connected to the conductive block through the isolating column; and
pluralities of heating conductive strips of the plurality of heating units connected to the isolating column are electrically connected through a connecting heating block.

2. The graphite heating device according to claim 1, wherein:
multiple heating conductive strips are provided between two adjacent conductive blocks; and
the multiple heating conductive strips are provided in parallel to each other.

3. The graphite heating device according to claim 2, wherein the two adjacent conductive blocks are connected to each other by an insulating plate.

4. The graphite heating device according to claim 3, wherein:
a longitudinal cross-section of the conductive block is in an L-shape; and
another one of the plurality of heating conductive strips is connected to the conductive block via a conductive screw.

5. The graphite heating device according to claim 4, wherein the isolating column is provided on an outer surface of the conductive block.

6. The graphite heating device according to claim 4, wherein:
the plurality of heating conductive strips are graphite heating conductive strips;
the conductive block is a graphite conductive block;
the connecting conductive strip is a graphite connecting conductive strip; and
the connecting heating block is a graphite connecting heating block.

7. The graphite heating device according to claim 3, wherein the isolating column is an insulating isolating column.
